(19) United States
(12) Patent Application Publication
(10) Pub. No.: US 2026/0106704 A1
(43) Pub. Date: Apr. 16, 2026

(54) ACCESS POINT COORDINATION IN UPLINK AND DOWNLINK COEXISTENCE

(71) Applicant: TELEFONAKTIEBOLAGET LM ERICSSON (PUBL), Stockholm (SE)

(72) Inventors: Hiroki Iimori, Kanagawa (JP); Jorg Huschke, Köln (DE); Joao Vieira, Hjärup (SE)

(21) Appl. No.: 19/114,955

(22) PCT Filed: Nov. 11, 2022
(86) PCT No.: PCT/EP2022/081596

§ 371 Date: Mar. 25, 2025

(51) Int. Cl. H04L 5/00; H04B 17/309

(52) U.S. Cl. CPC H04L 5/0044; H04B 17/346

(57) ABSTRACT

A computer-implemented method for access point assignment in a wireless communications network where multiple access points simultaneously serve multiple wireless devices, and where some of the multiple wireless devices are scheduled for uplink and some of wireless devices are scheduled for downlink. The method comprises monitoring link characteristics between the access points and the wireless devices over time. The method further comprises determining, when at least one link characteristic changes more than a predetermined amount, a utility function based on the monitored link characteristics, wherein the utility function is a function of a predetermined utility in terms of link quality in the wireless communications network versus a possible uplink or downlink assignment for each access point. The method also comprises assigning one or more access points to operate in either uplink or downlink based on the utility function.

### TECHNICAL FIELD

The present disclosure relates generally to the field of wireless communication. More particularly, it relates to a method for uplink and downlink assignments for access points (APs) in a wireless communications network where multiple APs simultaneously serve multiple wireless devices; such wireless communications network is sometimes referred to as a distributed multiple-input and multiple-output (D-MIMO) network.

### BACKGROUND

In wireless communications, multiple-input and multiple-output (MIMO) is a technology utilizing multiple transmission antennas and receiving antennas to increase capacity. Distributed MIMO (D-MIMO), also known as cell-free MIMO, Radio Stripes etc., is a key technology candidate for the sixth generation (6G) physical layer in wireless communications. The basic idea in D-MIMO is to distribute antennas geographically and have them operate together. A typical architecture is that multiple antenna panels (also known as access points, APs) are interconnected and configured in such a way that they may cooperate phase-coherently. Each AP in turn may comprise multiple antenna elements that are also configured to operate phase-coherently together, so that all antennas of all APs together effectively form a large, coherently operating antenna array. The link resulting from such spatial distribution of APs typically yields higher spatial degrees-of-freedom (compared to non-distributed, i.e., co-located, MIMO setups). Such degrees-of-freedom may be exploited in a number of ways, e.g., they may be exploited to ensure fairer signal to noise ratio (SNR) distributions among user equipments (UEs), larger number spatially multiplexed data streams, and larger link robustness.

It is envisioned that future D-MIMO deployments will provide an excess number of distributed APs (i.e. many more APs than active UEs). Each distributed AP is further expected to operate with half-duplex technology since full-duplex technology is still relatively immature and expensive to realize. Nevertheless, an excess number of half-duplex APs may effectively be utilized to realize a network yielding some of the advantages of full-duplex-like communications (without using a real full-duplex hardware). Such advantages are e.g. communications with lower latency and potential higher spectrum efficiency. To elaborate, suppose there are a large number of half-duplex APs distributed over a service area and each AP operates either in downlink (DL) or uplink (UL) mode at the same time and frequency according to the current needs. With that, some APs will be receiving in UL and, at the same time and frequency, other APs will be transmitting in DL. From a system-level point of view, the network may be thought as performing full-duplex communications.

Such a way of operating a D-MIMO network, and additional challenges resulting from it, has some resemblance with dynamic time division duplex (DTDD), which has been discussed and standardized over the last decade in the context of traditional cellular systems. Here, UL and DL transmissions are dynamically switched depending on the UL/DL demand at each cell. A drawback resulting from such switching flexibility is that of additional inter-cell cross-link interference. Such interference comprise DL-to-UL interference between two base stations (e.g., gNB-to-gNB interference), and UL-to-DL interference between two UEs (i.e. UE-to-UE interference). In traditional cellular systems, there is no central coordination and no phase coherent joint signal processing between gNBs operating at different locations.

A similar type of cross-link interference will occur in a D-MIMO network that operates as described above, except that it will be “intra-cell” cross-link interference in the form of AP-to-AP interference and UE-to-UE interference. In this case, cell means the service area for the D-MIMO network.

To summarize, a D-MIMO network combined with DTDD concept offers a more flexible duplex option that is able to harvest full duplex-like benefits in the communication performance. However, the best way of implementing such system remains an open-ended question.

### SUMMARY

It is an object of the present disclosure to mitigate, alleviate or eliminate one or more of the above-identified deficiencies and disadvantages in the prior art and solve at least the above-mentioned problem. In particular, an object is to provide improved wireless communications networks where multiple access points simultaneously serve multiple wireless devices. This object is obtained at least in part by a computer-implemented method for access point assignment in a wireless communications network where multiple access points simultaneously serve multiple wireless devices. Some of the multiple wireless devices are scheduled for uplink and some of the multiple wireless devices are scheduled for downlink. The method comprises monitoring link characteristics between the access points and the wireless devices over time. The method further comprises determining, when at least one link characteristic changes more than a predetermined amount, a utility function based on the monitored link characteristics. The utility function is a function of a predetermined utility in terms of link quality in the wireless communications network versus a possible uplink or downlink assignment for each access point. The method also comprises assigning one or more access points to operate in either uplink or downlink based on the utility function. Preferably, each access point is assigned to operate in either uplink or downlink.

The disclosed method enables a wireless communications network with low communication fronthaul overhead, low computational cost, and low latency. The disclosed method may reassign access point only when it is deemed likely to have an effect of the overall performance of the wireless communications network. Assignments are kept when the channel statistics remain relatively unchanged, i.e., when the condition that at least one link characteristic changes more than the predetermined amount is not met.

The link characteristics over time may represent long-term channel statistics. The disclosed method may only update an access point assignment once per time it takes for the long-term channel statistics involving active UEs and APs to change. A change in a link characteristic may occur if e.g. a wireless device moves from one position to another. After such change, the path gain of that wireless device to the APs will likely change. In that case, an update of access point assignments may lead to improved performance of the wireless communications network, such as improved overall total data capacity in the network. Furthermore, when the wireless device moves from the first position to the second position, it is likely that the inter-cell interference will change. Which also may motivate an update in access point assignment. Link characteristics may also change for other reasons.

According to some aspects, the method further comprises communicating the uplink and downlink assignments to the corresponding access points. For example, if the method is performed by a data processing unit, the data processing unit may communicate an UL or DL assignment to each AP, via e.g. high-capacity backhaul links.

According to some aspects, the link characteristics comprise any of path gain, received power, transmitted power, signal-to-noise ratio, SNR, signal-to-interference-plus-noise ratio, SINR, spatial channel correlation, and channel rank. Other link characteristics are also possible. According to some aspects, the predetermined utility comprises any of path gain, received power, transmitted power, SNR, SINR, spatial channel correlation, channel rank and data capacity. Any of these utilities may be used to effectively assign the APs to achieve high performance in the wireless communications network, e.g. in terms of data capacity. Furthermore, using only one of the mentioned example utilities, such as path gain, may be sufficient to arrive at an assignment that is close to a global optimum solution in terms of e.g. data capacity, while requiring significantly less computational resources comped to e.g. an exhaustive search over all possible assignments of the APs that directly tries to maximize data capacity. Other link utilities are also possible.

According to some aspects, the utility comprises information of interference from one or more access point and/or one or more wireless devices in the wireless communications network. This way, the utility function may account for interference when, e.g., maximizing intended signal powers. This may help in finding an assignment that is close to a global optimum solution, in terms of e.g. data capacity, while being computationally efficient.

According to some aspects, the wireless communications network comprises a number M access points and a number N wireless devices scheduled for uplink or downlink, where M is larger than N. In that case, the method comprises selecting N access points out of M possible access points using a one-by-one assignment to respective wireless devices based on the predetermined utility. The method further comprises selecting iteratively N access points out of a set of remaining access points that are different access points from the previously selected access points, using a one-by-one assignment to respective wireless devices based on the predetermined utility. The method also comprises assigning each access point selected for a wireless device scheduled for uplink transmission to operate in uplink, and assigning each access point selected for a wireless device scheduled for downlink transmission to operate in downlink.

This assignment strategy is much more computationally efficient compared to an exhaustive search. The one-by-one assignment may e.g. be based on the Munkres algorithm. The Munkres algorithm is particularly computationally efficient since it solves assignment problems in polynomial time.

According to some aspects, the utility function comprises a first utility for wireless devices scheduled for uplink and a second utility for wireless devices scheduled for downlink. This way, the utility function may maximize different desired link aspects for uplink and downlink transmissions.

According to some aspects, the utility function comprises a matrix, where each entry of the matrix corresponds to a pair of an access point and a wireless device, and where each entry comprises a link characteristic for the corresponding pair of access point and wireless device. In other words, the assignment strategy comprises a matrix. The matrix may also be called a utility matrix. The matrix representation allows for computationally efficient assignment of the APs. Furthermore, each entry may be scaled by interference from other access points and/or wireless devices than said pair of access point and wireless device.

According to some aspects, each entry is normalized according to a predetermined normalization function. For example, the normalization function is based on the softmax function. This may help the method resolve a bias caused by order-of-magnitude difference between quantities in the matrix. Similarly, any type of normalization techniques may be used to enhance the performance of the computations.

According to some aspects, the method further comprises monitoring whether the at least one link characteristic changes more than the predetermined amount in a predetermined time interval. This may further reduce computational overhead and latency on average. For example, an investigation if the at least one link characteristic has changed may occur every 1 seconds. More generally, however, the predetermined time interval may be 0.1-10 seconds. However, the predetermined time interval may be any number. The predetermined time interval may be static or dynamic. For example, the predetermined time interval may be based on past link characteristics. This may additionally reduce computational overhead and latency on average since the monitoring is not done when it is likely to be unnecessary, i.e., when nothing is likely to have changed in the network. In an example scenario, a wireless device has been stationary for 10 minutes. In that case, the predetermined time interval is currently 10 seconds. Then, the wireless device moves, which changes the link characteristics. The predetermined time interval is then dynamically changed to 1 second. This is an example of a reactive change of the predetermined time interval. The predetermined time interval may alternatively, or in combination of, be dynamically changed proactively. This may additionally reduce computational overhead and latency on average for similar reasons. In other words, the predetermined time interval may be based on an expected time the respective wireless devices are expected to move less than a predetermined distance.

There is also disclosed herein a node for access point assignment in a wireless communications network where multiple access points simultaneously serve multiple wireless devices, and where some of the multiple wireless devices are scheduled for uplink and some of the multiple wireless devices are scheduled for downlink. The node is associated with the above-discussed advantages. The node comprises a processing circuitry and a memory. The processing circuitry is configured to monitor link characteristics between the access points and the wireless devices over time. The processing circuitry is further configured to determine, when at least one link characteristic changes more than a predetermined amount, a utility function based on the monitored link characteristics, wherein the utility function is a function of a predetermined utility in terms of link quality in the wireless communications network versus a possible uplink or downlink assignment for each access point. The processing circuitry is also configured assign one or more access points to operate in either uplink or downlink based on the utility function. Preferably, each access point is assigned either uplink or downlink.

There is also disclosed herein a computer program product comprising instructions which, when executed on at least one processing circuitry, cause the at least one processing circuitry to carry out the method according to the discussion above. The computer program is associated with the above-discussed advantages.

There is also disclosed herein a computer program carrier carrying a computer program product according to the discussion above, wherein the computer program carrier is one of an electronic signal, optical signal, radio signal, or computer-readable storage medium. The computer program carrier is associated with the above-discussed advantages.

### BRIEF DESCRIPTION OF THE DRAWINGS

With reference to the appended drawings, below follows a more detailed description of embodiments of the present disclosure cited as examples. In the drawings:

FIGS. 1-2 are schematic illustrations of a wireless communications networks;

FIGS. 3-5 are flow charts illustrating methods;

FIG. 6 shows spectrum efficiency for various access point assignment; and

FIG. 7 schematically illustrates an access point or a data processing unit.

### DETAILED DESCRIPTION

The present disclosure is described below with reference to the accompanying drawings, in which certain aspects of the present disclosure are shown. The present disclosure may, however, be embodied in many different forms and should not be construed as limited to the embodiments and aspects set forth herein; rather, these embodiments are provided by way of example so that this disclosure will be thorough and complete, and will fully convey the scope of the present disclosure to those skilled in the art. Like numbers refer to like elements throughout the description.

It is to be understood that the present disclosure is not limited to the embodiments described herein and illustrated in the drawings; rather, the skilled person will recognize that many changes and modifications may be made within the scope of the appended claims.

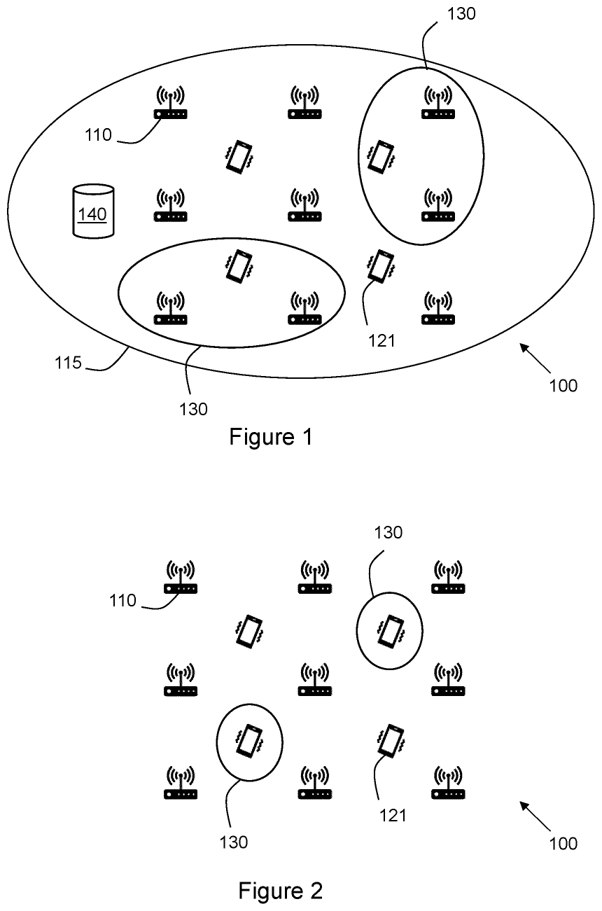

FIG. 1 depicts a wireless communications network 100 in which embodiments herein may operate. FIG. 2 shows aspects of the wireless communications network 100 from FIG. 1. In some embodiments, the wireless communications network 100 may be a radio communications network, such as, 6G, NR or NR+ telecommunications network. However, the wireless communications network 100 may also employ technology of any one of 3/4/5G, LTE, LTE-Advanced, WCDMA, GSM/EDGE, WiMax, UMB, GSM, or any other similar network or system. The wireless communications network 100 may also employ technology transmitting on millimeter-waves (mmW), such as, e.g. an Ultra Dense Network, UDN. In some embodiments, the wireless communications network 100 may also employ transmissions supporting WiFi transmissions, e.g. the wireless communications standard IEEE 802.11ad or similar, or other non-cellular wireless transmissions.

In particular, the wireless communications network in FIG. 1 is a distributed multiple-input and multiple-output (D-MIMO) network, where access points (APs) 110 are geographically spread out over an area, in a planned or random fashion. The APs are arranged in communication with a data processing unit 140 through e.g. high-capacity backhaul links (such as fiber optic cables). The data processing unit 140 may e.g. be a remote standalone server, a cloud-implemented server, a distributed server, dedicated data processing resources in a server farm, or similar.

The APs 110 may serve wireless devices 121 in at least one cell 115, or coverage area. The APs 110 may correspond to any type of network node or radio network node capable of communicating with a wireless device and/or with another network node, such as, a base station (BS), a radio base station, gNB, eNB, eNodeB, a Home NodeB, a Home eNodeB, a femto Base Station (BS), or a pico BS in the wireless communications network 100.

As is also shown in FIG. 1, a plurality of wireless devices 121 are located within the cell 115. Each wireless device 121 is configured to communicate within the wireless communications network 100 via the APs 110 over radio links served by the APs 110. The wireless devices 121 may transmit data over an air or radio interface to one or more APs 110 in uplink (UL) transmissions and the APs 110 may transmit data over an air or radio interface to one or more wireless devices 121 in downlink (DL) transmissions. The wireless devices 121 may refer to any type of wireless devices or user equipment (UE) communicating with a network node and/or with another wireless device in a cellular, mobile or radio communication network or system. Examples of such wireless devices are mobile phones, cellular phones, Personal Digital Assistants (PDAs), smart phones, tablets, sensors equipped with a UE, Laptop Mounted Equipment (LME) (e.g. USB), Laptop Embedded Equipment (LEE), Machine Type Communication (MTC) devices, or Machine to Machine (M2M) device, Customer Premises Equipment (CPE), target device, device-to-device (D2D) wireless device, wireless device capable of machine to machine (M2M) communication.

Each distributed AP in the example wireless communications network 100 in FIG. 1 is operating with half-duplex. The circles 130 represent wireless devices and APs operating in UL. The remainder of wireless devices and APs are operating in DL.

As previously noted, dynamic time division duplex (DTDD) D-MIMO operation may result in a cross-link interference problem similar to that existing in between cells in conventional cellular communications networks when each cell performs DTDD communications. In the conventional cellular DTDD, each cell may dynamically change its duplex mode depending on the demand from users located within the cell, resulting in the fact that DL base stations (e.g., Next Generation Node B, gNB) cause interference towards neighboring UL base stations, and UL users cause interference towards DL users in different neighboring cells.

Also as previously noted, a similar type of (intra-cell) cross-interference may occur in DTDD D-MIMO, i.e. AP-to-AP interference. However, it should be noted that there is typically more flexibility to address such interference in D-MIMO systems since it is much easier to coordinate APs in the same cell, compared with coordinating base stations in different cells.

As part of the developing of the embodiments described herein, it has been realized that the best way to assign APs in a D-MIMO system is an open-ended problem. In DTDD D-MIMO, a suitable set of APs should be assigned to operate in DL and another suitable set of APs should be assigned to operate in UL. This is because the configurations of the APs directly affects how each AP interferes with each other. Such interference between APs should be kept under control. We hereafter refer to this problem as a UL/DL AP assignment problem.

In the literature, a few approaches for AP assignment have been suggested.

Shuto Fukue et al. propose an optimization-based approach that jointly design AP assignment and beamforming weights by means of non-convex optimization techniques in “Joint Access Configuration and Beamforming for Cell-Free Massive MIMO Systems With Dynamic TDD”, IEEE Access, vol. 10, April 2022.

Yue Zhu et al. suggest using a specific type of convex relaxation methods (i.e., parallel convex relaxation) to improve the spectrum efficiency by designing AP assignment in “Optimization of Duplex Mode Selection for Network-Assisted Full-Duplex Cell-Free Massive MIMO Systems”, IEEE Commun. Lett., vol. 25, no. 11, November 2021.

Jiamin Li et al. use a random AP assignment method in the context of channel estimation in DTDD D-MIMO in “Network-Assisted Full-Duplex Distributed Massive MIMO Systems With Beamforming Training Based CSI Estimation”, IEEE Trans. Wireless Commun., vol. 20, no. 4, April 2021.

Dongming Wang et al. propose a user scheduling method to avoid the aforementioned cross interference in “Performance of Network-Assisted Full-Duplex for Cell-Free Massive MIMO” IEEE Trans. Commun., vol. 68, no. 3, March 2020.

AP assignment may be done at a given point in time based on the instantaneous channel state information (CSI). However, such instantaneous CSI-based assignments may pose the following issues:
high measurement overhead for measuring and possibly reporting instantaneous CSI that may change rapidly with movement of UEs or of objects in the environment,
high computational cost due to the fact that AP UL/DL configuration needs to be updated every time the instantaneous CSI changes (i.e. once per channel coherent time),
high communication overhead on fronthaul links between APs and their central computing unit, and
high latency due to multiple re-configurations of APs based on short-term CSI.

In contrast to such approaches, where the UL/DL AP assignment needs to be updated once per channel coherence time (e.g. once per new radio, NR, slot in the worst case), the disclosed approach only requires an AP assignment update once per time it takes for the long-term channel statistics to change. This results in a system yielding benefits similar to those of full-duplex communications, but with 1) lower communication fronthaul overhead, 2) the computational cost, and 3) latency. Moreover, as is shown further below, simulations show that the performance of the embodiments of the disclosed methodologies are also comparable to the ideal case, where an exhaustive search with instantaneous CSI knowledge is performed. In other words, the embodiments of the disclosed method herein present almost as good performance as the global optimum solution for AP assignment, while requiring significantly less computational resources in terms of computational cost and latency.

The system shown in FIG. 1 is a DTDD D-MIMO system serving multiple UL/DL UEs at the same time. Although the methods disclosed herein are suitable for any types of wireless devices, UEs are used as an example in the disclosed embodiments herein. For simplicity, is it assumed that each AP is equipped with a number 0 antennas and each UE is equipped with a number P antennas, in which all the radio devices are assumed to operate in half-duplex mode. However, the teachings of this disclosure is also applicable to the more general case where the number of antennas vary per UE and/or per AP. Furthermore, it is assumed that the network knows the current UL/DL demand from all UEs (i.e., which UE would like to operate in UL/DL). In other words, the data processing unit 140 and/or APs may be configured to receive UL/DL demands from wireless devices in the wireless communications network 100.

An objective may be to find an optimal set of APs serving in the UL and DL, respectively. Preferably, a global optimum is found. However, other assignments than the global optimum (such as local optimums) may be more desirable if they can be found with less computational power without sacrificing much overall performance. Note that since each AP is assumed to only be capable of half-duplex communications, an AP assigned to UL group may not transmit in the DL simultaneously, and vice versa. For the sake of later convenience, let [symbol] ᵤ and [symbol] _{d} be the set of APs operating in UL and DL, respectively.

Since the system serves UL and DL at the same time and frequency, the system may suffer from cross-link interference, i.e., interference from DL APs to UL APs, and interference from UL UEs to DL UEs. To elaborate, denoting kᵤ as an UL UE index with kᵤ ∈ [symbol] ᵤ and [symbol] ᵤ being the set of UL UEs, the kᵤ-th UL signal (ŝₖ_{ᵤ}) at the central computing unit, after collecting the received signal from each UL AP, may be written as

$${\hat{s}}_{{k}_{u}} = ( {\sum }_{l ∈ {ℒ}_{u}} {v}_{{k}_{u} l}^{H} {H}_{{k}_{u} l} {f}_{{k}_{u}} ) {s}_{{k}_{u}} + {\sum }_{i ∈ {𝒦}_{u} , i \neq {k}_{u}} ( {\sum }_{l ∈ {ℒ}_{u}} {v}_{{k}_{u} l}^{H} {H}_{il} {f}_{i} ) {s}_{i} + {\underbrace{{\sum }_{l ∈ {ℒ}_{u}} {v}_{{k}_{u} l}^{H} ( {\sum }_{{l}^{′} ∈ {ℒ}_{d}} {\ddot{H}}_{{ll}^{′}} ( {\sum }_{{k}^{′} ∈ {𝒦}_{d}} {w}_{{k}^{′} {l}^{′}} {x}_{{k}^{′}} ) )}}_{Interference from DL APs to UL APs} + {\sum }_{l ∈ {ℒ}_{u}} {v}_{{k}_{u} l}^{H} {n}_{l} \qquad ( 1 )$$

where

$${ν}_{k l}^{H} ∈ {ℂ}^{1 \times O}$$

is the combining vector at the l-th AP with l∈ [symbol] ᵤ to detect signal from the kᵤ-th UL UE; Hₖₗ∈ [symbol] ^{O×P} denotes the channel matrix between k-th UE and l-th AP; f kᵤ ∈ [symbol] ^{P×1} is the precoding vector at kᵤ-th UL UE; Hᵤ ∈ [symbol] ^{O×O} is the cross-AP channel matrix between l-th UL AP and l′-th DL AP; W_{k′l′} ∈ [symbol] ^{O×1} denotes the precoding vector at l′-th DL AP towards k′-th DL UE; nₗ ∈ [symbol] ^{1×O} is the noise vector at l-th UL AP.

Similarly, the received signal (\hat{x}k_{d}) at k_{d}-th DL UE may be written as

$${\hat{x}}_{{k}_{d}} = {g}_{{k}_{d}}^{H} ( {\sum }_{l ∈ {ℒ}_{d}} {H}_{{k}_{d} l}^{T} {w}_{{k}_{d} l} {x}_{{k}_{d}} + {\sum }_{l ∈ {ℒ}_{d}} {H}_{{k}_{d} l}^{T} {\sum }_{i ∈ {𝒦}_{d} , i \neq k} {w}_{il} {x}_{i} + {\underbrace{{\sum }_{{k}^{′} ∈ {𝒦}_{u}} {\dot{H}}_{{k}_{d} {k}^{′}} {f}_{{k}^{′}} {s}_{{k}^{′}}}}_{\begin{matrix}Interference from UL UEs \\ to DL UEs\end{matrix}} + {n}_{{k}_{d}} ) \qquad ( 2 )$$

where

$${g}_{{k}_{d}}^{H} ∈ {ℂ}^{1 \times P}$$

is the combining vector at k_{d}-th DL UE, nₖ_{_{d}} ∈ [symbol] ^{1×P} is the noise vector at k_{d}-th DL UE, the channel UL/DL reciprocity is assumed, and

$${\dot{H}}_{{k}_{d} {k}^{′}} ∈ {ℂ}^{P \times P}$$

is the interference channel matrix from the k′-th UL UE to k_{d}-th DL UE.

A problem addressed in this disclosure is how to design the sets [symbol] ᵤ and [symbol] _{d} such that a certain utility is maximized. This is due to the fact that the assignment of APs is likely to impact the signal-to-interference-plus-noise ratio (SINR) of equation (1) and (2). To be more concrete, a general formulation for the UL/DL AP assignment may be written as

$${max}_{{ℒ}_{u} , {ℒ}_{d}} {\underbrace{{\sum }_{{𝓀}_{u} ∈ {𝒦}_{u}} {𝒰}_{{k}_{u}}^{UL} ( {ℒ}_{u} , {ℒ}_{d} )}}_{Sum - Utility of UL} + {\underbrace{{\sum }_{{𝓀}_{d} ∈ {𝒦}_{d}} {𝒰}_{{k}^{′}}^{DL} ( {ℒ}_{u} , {ℒ}_{d} )}}_{Sum - Utility of DL} subject to {ℒ}_{u} ⋂ {ℒ}_{d} = ∅ and \vert {ℒ}_{u} \vert + \vert {ℒ}_{d} \vert = L \qquad ( 3 )$$

in which

$${𝒰}_{{k}_{u}}^{UL} ( {ℒ}_{u} , {ℒ}_{d} ) and {𝒰}_{{k}_{d}}^{DL} ( {ℒ}_{u} , {ℒ}_{d} )$$

denotes a certain utility function for UL and DL, respectively. Here, ∩ denotes set intersection, Ø denotes the empty set, and | [symbol] ᵤ| denotes the cardinality of set [symbol] ᵤ.

The utility functions of UL/DL may be determined as a functions depending only on the instantaneous CSI. However, the UL/DL AP assignment should preferably be performed based on long-term statistics of the channels. For this reason, according to one embodiment, we instead propose to use the following utility:

$${𝒰}_{{k}_{u}}^{UL} ( {ℒ}_{u} , {ℒ}_{d} ) = \frac{{\sum }_{l ∈ {ℒ}_{u}} P {G}_{{k}_{u} l}^{U E - A P}}{{\sum }_{{l}^{′} ∈ {ℒ}_{d}} P {G}_{{ll}^{′}}^{A P - A P}} \qquad ( 4 )$$

$${𝒰}_{{k}_{d}}^{DL} ( {ℒ}_{u} , {ℒ}_{d} ) = \frac{{\sum }_{l ∈ {ℒ}_{d}} P {G}_{{k}_{d} l}^{U E - A P}}{{\sum }_{k ∈ {ℒ}_{u}} P {L}_{{kk}_{d}}^{U E - U E}} \qquad ( 5 )$$

where

$$P {G}_{{k}_{u} l}^{U E - A P}$$

is the path gain of the channel

$${H}_{{k}_{u} l} , P {G}_{{ll}^{′}}^{A P - A P}$$

denotes the path gain of the channel

$${\ddot{H}}_{{ll}^{′}} , {PL}_{{kk}^{′}}^{U E - U E}$$

is the path gain of UE-UE channels between k-th UL UE and k_{d}-th DL UE, and

$${PG}_{{k}_{d} l}^{U E - A P}$$

is the path gain of the channel

$${H}_{{k}_{d} l}^{T} .$$

The path gain here may be defined as the path gain of the raw propagation channels (i.e., without beamforming).

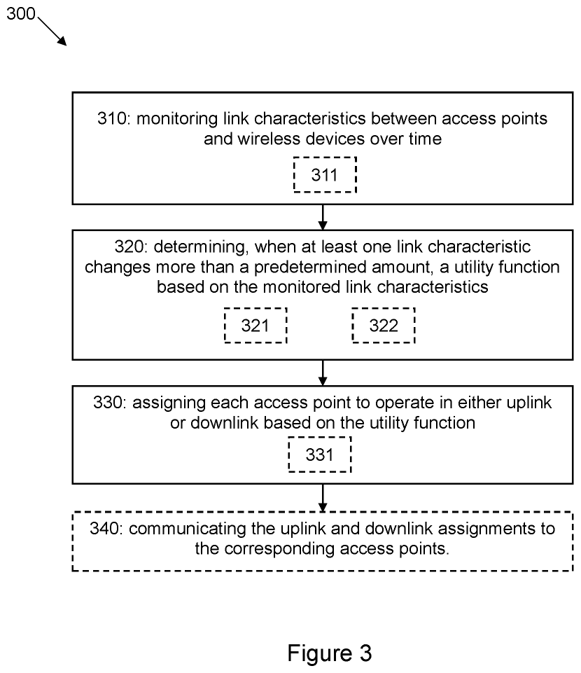

With reference to FIG. 3, there is disclosed herein a computer-implemented method 300 for AP assignment in a wireless communications network 100 where multiple APs 110 simultaneously serve multiple wireless devices 121. Here, simultaneously may mean using the same time resources and/or frequency resources. As mentioned, the wireless communications network 100 may be called a D-MIMO network. There are two or more APs and two or more wireless devices. However, in D-MIMO networks, there are typically a larger amount of APs and wireless devices, and the number of APs are typically 2-10 times larger than the number of wireless devises. In the wireless communications network 100, some of the multiple wireless devices are scheduled for UL and some of the multiple wireless devices are scheduled for DL. Here, some of the multiple wireless devices means one or more wireless devices of the multiple wireless devices. The wireless devices scheduled for UL are different wireless devices than those scheduled for DL. Note that the wireless communications network may comprise other wireless devices that are not currently scheduled for UL or DL. The method may thus comprise, receiving UL/DL demands from the wireless devices in the wireless communications network 100.

The method comprises monitoring 310 link characteristics between the APs 110 and the wireless devices 121 over time. When at least one link characteristic changes more than a predetermined amount, the method further comprises determining 320 a utility function based on the monitored link characteristics. The utility function is a function of a predetermined utility in terms of link quality in the wireless communications network 100 versus a possible uplink or downlink assignment for each AP. The method also comprises assigning 330 one or more APs to operate in either uplink or downlink based on the utility function. Preferably, each AP in the wireless communications network is assigned to operate in either uplink or downlink. The method may further comprise communicating 340 the UL and DL assignments to the corresponding APs 110. For example, if the method is performed by a data processing unit 140, the data processing unit may communicate an UL or DL assignment to each AP, via e.g. high-capacity backhaul links.

The link characteristics may in general comprise data indicative channels statistics in the wireless communications network 100. For example, the link characteristics may comprise any of path gain, received power, transmitted power, signal-to-noise ratio, SNR, signal-to-interference-plus-noise ratio, SINR, spatial channel correlation, and channel rank.

The links between APs 110 and the wireless devices 121 may be communication links. The links may also be called channels or communication channels. Such communication links may comprise UL and/or DL transmissions, including pilots. When a first wireless device transmits a pilot signal, this pilot signal is likely received by a plurality of APs (a first group). The APs in the first group may then extract link characteristics form these pilots, such as path gains of the respective links. APs in a second group, that do not receive the pilot (e.g., because the received signal strength is too low), may determine that the respective links between said wireless device and the APs in the second group are unsuitable for future UL/DL transmissions. Being unsuitable is also a link characteristic. Being unsuitable may be represented by a large path loss (i.e. low path gain) value, such as 1000 dB. The link characteristics (such as path gain) may be extracted from any signals between the wireless devices and APs.

The link characteristics over time represent long-term channel statistics. As mentioned, the disclosed method only requires an AP assignment update once per time it takes for the long-term channel statistics to change. In other words, the AP assignment is updated when at least one link characteristic changes more than a predetermined amount. Note that a given set of wireless devices are scheduled for UL and another set of wireless devices are scheduled for DL. Here, a set comprises one or more wireless devices. If any of these two sets changes, an updated assignment of the APs to operate in either UL or DL is likely desired.

A change in a link characteristic may occur if a wireless device moves from one position to another. After such change, the path gains of that wireless devise to the APs will likely change. This may mean that an update of AP assignments leads to improved performance of the wireless communications network, such as improved data capacity. The predetermined threshold may e.g. be 1 dB difference in path gain. Furthermore, when the wireless device moves from the first position to the second position, it is likely that the inter-cell interference will change. Which also may motivate an update in AP assignment.

The method may further comprise monitoring 311 whether the at least one link characteristic changes more than the predetermined amount in a predetermined time interval. For example, an investigation if the at least one link characteristic has changed may occur every 1 seconds. More generally, however, the predetermined time interval may be 0.1-10 seconds. However, the predetermined time interval may be any number.

The predetermined time interval may be static or dynamic. For example, the predetermined time interval may be based on past link characteristics. In an example scenario, a wireless device has been stationary for 10 minutes. In that case, the predetermined time interval is currently 10 seconds. Then, the wireless device moves, which changes the link characteristics.

The predetermined time interval is then dynamically changed to 1 second. This is an example of a reactive change of the predetermined time interval. The predetermined time interval may alternatively, or in combination of, be dynamically changed proactively. In other words, the predetermined time interval may be based on an expected time the respective wireless devices are expected to move less than a predetermined distance.

According to some aspects, the link characteristics is averaged over a predetermined amount of time. Here, averaging may mean to determine a mean value for at least to different values at respective different time instances.

As mentioned, the disclosed method comprises determining a utility function based on the monitored link characteristics. The utility function may e.g. be represented by equation (3), which maximizes a sum of a utility for UL and a sum of a utility for DL versus different UL/DL assignments of the APs. In other words, the utility function is a function of a predetermined utility in terms of link quality in the wireless communications network 100 versus a possible uplink or downlink assignment for each AP. The predetermined utility may e.g. comprise any of path gain, received power, transmitted power, SNR, SINR, spatial channel correlation, channel rank and data capacity. Furthermore, the utility may comprise information of interferences from one or more APs 110 and/or one or more wireless devices 121 in the wireless communications network 100.

In general, a utility may be used to model worth or value. A utility function may represent value for different choices. The utility function may be a function of a metric representing a high-level value of the wireless communications network, such as data capacity. However, the utility function may also be a function of a metric representing a more direct attribute of the wireless communications network, such as path gain. As is shown in the simulations further below, using such direct attributes may result in a network performance (e.g. in terms of data capacity) close to a global optimum assignment.

As an example, the utility function may aim to maximize an intended signal power between APs and UEs, while ignoring any interference part. Here, a maximum may be a global maximum or a local maximum. In particular, the intend signal power may be maximized by selecting an AP assignment that results in the maximum sum of path gains of the communication channels between APs and UEs.

Naturally, the utility function may also be used to minimize an undesired attribute, such as path loss. A utility function used such way is considered equivalent to maximizing a utility.

In other words, the utility function comprises information of some predetermined metric of the communications links in the wireless communications network. This metric may consider direct paths of the communication links (such as path gain). It may also consider interference from other APs and/or wireless devices in the wireless communications network.

Finding a global optimum of equation (3), based on e.g. the utilities in equations (4) and (5), would require a combinatorial optimization, which normally imposes a prohibitive computation cost and might not be completed within a reasonable time for large-scale D-MIMO systems. To address this issue, the disclosed method may utilize an assignment strategy based on a one-to-one assignment. This is discussed in more detail in the examples below.

Below is an example of an SNR maximization approach.

This approach intends to maximize the intended signal power from/to UEs, while ignoring the interference part. Here, maximize likely means achieving a local maximum. If interference is ignored, the method may rely on only path loss knowledge of AP-UE channels (i.e., there is no need for e.g. UE-UE and/or AP-AP path gain knowledge). Here, only the numerators

$${\sum }_{l ∈ {ℒ}_{u}} P {G}_{{k}_{u} l}^{U E - AP} and {\sum }_{l ∈ {ℒ}_{d}} {PG}_{{k}_{d} l}^{U E - A P}$$

of the utility expression in (4) and (5) above are considered.

FIG. 2 shows an illustration of a system with 4 UEs and 9 APs. Here, two UEs (see circles 130) are scheduled for UL and the other to UEs are scheduled for DL. The AP assignment is yet to be performed.

This example embodiment comprises of the following four steps.

Step1. Set the path gain information of AP-UE channels, and construct a utility matrix. For example, let's consider 4 UEs (2 in UL and 2 in DL) and 9 APs shown in FIG. 2. Here, the utility matrix constitutes the utility function.

In such scenarios, the utility matrix may be a matrix consisting of path gains (PGᵢⱼ, where i denotes an UE and j denotes an AP) of AP-UE channels. An example is shown in Table I below.

TABLE I
An example utility matrix

| | AP 1 | AP 2 | AP 3 | AP 4 | AP 5 | AP 6 | AP 7 | AP 8 | AP 9 |
|---|---|---|---|---|---|---|---|---|---|
| UE 1 | PG₁₁ | PG₁₂ | PG₁₃ | PG₁₄ | PG₁₅ | PG₁₆ | PG₁₇ | PG₁₈ | PG₁₉ |
| UE 2 | PG₂₁ | PG₂₂ | PG₂₃ | PG₂₄ | PG₂₅ | PG₂₆ | PG₂₇ | PG₂₈ | PG₂₉ |
| UE 3 | PG₃₁ | PG₃₂ | PG₃₃ | PG₃₄ | PG₃₅ | PG₃₆ | PG₃₇ | PG₃₈ | PG₃₉ |
| UE4 | PG₄₁ | PG₄₂ | PG₄₃ | PG₄₄ | PG₄₅ | PG₄₆ | PG₄₇ | PG₄₈ | PG₄₉ |

Step 2. Assign one AP to each UE by a one-by-one assignment algorithm such as the Munkres algorithm such that the sum of chosen path gains is maximized. The Munkres algorithm is sometimes called the Hungarian method. The Munkres algorithm is a combinatorial optimization algorithm that solves an assignment problem in polynomial time. The Munkres algorithm was first described by H. W. Kuhn in “The Hungarian method for the assignment problem”, Naval Research Logistics Quarterly, vol. 2, March 1955.

Once the one-by-one assignment is performed, fill in the columns corresponding to the chosen APs with zeros. This indicates that the APs that are already assigned cannot be assigned again. For example, let us assume that AP 2 and AP 9 are assigned to UE 1 and UE 4 (which are the UL UEs), respectively, while AP 3 and AP 7 are assigned to UE 2 and UE 3 (which are the DL UEs), respectively. Then, the utility matrix is updated according to the example shown in Table II below. Note that removing the columns corresponding to the assigned APs is identical to filling them with zeros.

TABLE II
An example utility matrix

| | AP 1 | AP 2 | AP 3 | AP 4 | AP 5 | AP 6 | AP 7 | AP 8 | AP 9 |
|---|---|---|---|---|---|---|---|---|---|
| UE 1 | PG₁₁ | 0 | 0 | PG₁₄ | PG₁₅ | PG₁₆ | 0 | PG₁₈ | 0 |
| UE 2 | PG₂₁ | 0 | 0 | PG₂₄ | PG₂₅ | PG₂₆ | 0 | PG₂₈ | 0 |
| UE 3 | PG₃₁ | 0 | 0 | PG₃₄ | PG₃₅ | PG₃₆ | 0 | PG₃₈ | 0 |
| UE 4 | PG₄₁ | 0 | 0 | PG₄₄ | PG₄₅ | PG₄₆ | 0 | PG₄₈ | 0 |

Step 3. If all APs are assigned, proceed to Step 4; otherwise, return to Step 2 with the updated utility matrix.

Step 4. Output the set of UL and DL APs, namely [symbol] ᵤ and [symbol] _{d}, and end the process

In the example steps above, the fraction of the number of APs over the number of UEs is not an integer. After 8 APs have been assigned, a single AP remains. This remaining AP may be assigned to the UE with the highest path gain.

Below are further embodiments of the four examples steps above.

As an embodiment, SNR including the noise power and transmit power at each UE and AP may be utilized instead of the path gain quantities used in the above example. Here it may be assumed that the noise power does not vary much between APs and UEs. This is the case if the utility matrix contains UL SNRs (instead of path gains). In the DL case, the utility matrix may also be comprised of DL SNR where UE measurement noise power and transmit power from each AP are considered

Note that there may be two utility matrices: one for UL and one for DL. These two utility matrices may then be combined into one utility matrix, so that the steps above may be performed. The combination could be, e.g., in terms of simply summing entry-by-entry of the two utility matrices.

Below is an example of a cross-interference-aware approach.

In another extension of the SNR-maximization approach, a cross-interference-aware approach may be used to consider SINR (instead of SNR or path loss). Here, an interference measure may be computed in the DL, for a given DL UE, by summing the path gains (or received signal strengths) with respect to the signals transmitted by other UEs (currently transmitting in the UL). In the UL, an interference measure may also be computed for a given AP, by summing the path gains (or received signal strengths) with respect to the signals transmitted by other DL APs.

In another embodiment, the cross-interference-aware approach intends to maximize the intended signal power, while trying to minimize the cross-interference by considering the utility function in equations (4) and (5). This approach also contains four steps, which are presented below.

Step 1. Get the path gain information of AP-UE channels, making a utility matrix as shown in the previous section.

Step 2. Assign one AP to each UE by a one-by-one assignment algorithm such as the Munkres algorithm such that the sum of chosen path gains is maximized. Once the one-by-one assignment is performed, fill in the columns corresponding to the chosen APs with zeros and divide the unchosen path gains of UL-UEs by the total interference power from chosen APs and the unchosen path gains of DL-UEs by the total interference from UL-UEs. The resulting utility matrix is shown in Table III below.

TABLE III
An example utility matrix

| | AP 1 | AP 2 | AP 3 | AP 4 | AP 5 | AP 6 | AP 7 | AP 8 | AP 9 |
|---|---|---|---|---|---|---|---|---|---|
| UE1 | $\frac{{PG}_{11}}{\begin{matrix}{PG}_{13}^{AP - AP} + \\ {PG}_{17}^{AP - AP}\end{matrix}}$ | 0 | 0 | $\frac{{PG}_{14}}{\begin{matrix}{PG}_{43}^{AP - AP} + \\ {PG}_{47}^{AP - AP}\end{matrix}}$ | $\frac{{PG}_{15}}{{PG}_{53}^{AP - AP} + {PG}_{57}^{AP - AP}}$ | $\frac{{PG}_{16}}{{PG}_{63}^{AP - AP} + {PG}_{67}^{AP - AP}}$ | 0 | $\frac{{PG}_{18}}{{PG}_{83}^{AP - AP} + {PG}_{87}^{AP - AP}}$ | 0 |
| UE2 | $\frac{{PG}_{21}}{\begin{matrix}{PG}_{12}^{UE - UE} + \\ {PG}_{42}^{UE - UE}\end{matrix}}$ | 0 | 0 | $\frac{{PG}_{24}}{{PG}_{12}^{UE - UE} + {PG}_{42}^{UE - UE}}$ | $\frac{{PG}_{25}}{{PG}_{12}^{UE - UE} + {PG}_{42}^{UE - UE}}$ | $\frac{{PG}_{26}}{{PG}_{12}^{UE - UE} + {PG}_{42}^{UE - UE}}$ | 0 | $\frac{{PG}_{28}}{{PG}_{12}^{UE - UE} + {PG}_{42}^{UE - UE}}$ | 0 |
| UE3 | $\frac{{PG}_{31}}{\begin{matrix}{PG}_{13}^{UE - UE} + \\ {PG}_{43}^{UE - UE}\end{matrix}}$ | 0 | 0 | $\frac{{PG}_{34}}{{PG}_{13}^{UE - UE} + {PG}_{43}^{UE - UE}}$ | $\frac{{PG}_{35}}{{PG}_{13}^{UE - UE} + {PG}_{43}^{UE - UE}}$ | $\frac{{PG}_{36}}{{PG}_{13}^{UE - UE} + {PG}_{43}^{UE - UE}}$ | 0 | $\frac{{PG}_{38}}{{PG}_{13}^{UE - UE} + {PG}_{43}^{UE - UE}}$ | 0 |
| UE4 | $\frac{{PG}_{41}}{\begin{matrix}{PG}_{13}^{AP - AP} + \\ {PG}_{17}^{AP - AP}\end{matrix}}$ | 0 | 0 | $\frac{{PG}_{44}}{{PG}_{43}^{AP - AP} + {PG}_{47}^{AP - AP}}$ | $\frac{{PG}_{45}}{{PG}_{53}^{AP - AP} + {PG}_{57}^{AP - AP}}$ | $\frac{{PG}_{56}}{{PG}_{63}^{AP - AP} + {PG}_{67}^{AP - AP}}$ | 0 | $\frac{{PG}_{48}}{{PG}_{83}^{AP - AP} + {PG}_{87}^{AP - AP}}$ | 0 |

In Table III,

$$P {G}_{{ll}^{′}}^{A P - A P}$$

denotes the path gain of the channel between the l-th AP and l′-th AP,

$$P {G}_{{ll}^{′}}^{UE - UE}$$

denotes the path gain of the channel between the l-th UE and l′-th UE. By incorporating the interference power from chosen APs, the mechanism may take the AP-AP interference into consideration.

Step 3. If all APs are assigned, proceed to Step 4; otherwise, return to Step 2 with the updated utility matrix.

Step 4. Output [symbol] ᵤ and [symbol] _{d}, and end the process.

As an embodiment, SNR including the noise power and transmit power from each UE may also be utilized instead of the scaled path gain quantities used in the above example. As a further embodiment, a normalization function such as softmax function may be utilized such that the quantities in the table stay between a certain lower and upper bound (e.g., 0 and 1 in case of softmax, respectively), while maintaining the order of values. For example, let us define qᵢₗ as a quantity of the utility matrix at i-th row and j-th column. Then, the modified quantity after normalization via softmax (i.e., \hat{q}ᵢⱼ) may be written as

$${\hat{q}}_{ij} = \frac{{q}_{ij}}{{Σ}_{l = 1}^{L} {q}_{il}} \qquad ( 6 )$$

By this modification, the quantity after normalization via softmax becomes a value between 0 and 1, while maintaining the utility order within each row as is in the utility matrix before normalization. This may help the method resolve a bias caused by order-of-magnitude difference between quantities in the utility matrix. Similarly, any type of normalization techniques may be used to enhance the performance.

In one embodiment, long-term statistics of the channels such as the spatial channel correlation is utilized, which may be incorporated into the disclosed approaches as follows. For example, if the covariance matrix (i.e., spatial channel correlation) of each AP-UE link is known, the rank of the covariance matrix as well as its eigenvalues may be utilized to rescale the path gain quantities in the table such that it incorporates information about the effective sub-space(s) of a given channel matrix.

To summarize the approaches discussed in connection to Tables I-III, and referring once again to FIG. 3, the wireless communications network 100 may comprise a number M APs 110 and a number N wireless devices 121 scheduled for uplink or downlink, where M is larger than N. As mentioned, there may be other wireless devices in the wireless communications network that are not currently scheduled for uplink or downlink. Here the numbers M and N are integers. In that case, the method may comprise selecting 321 N APs 110 out of M possible APs using a one-by-one assignment to respective wireless devices 121 based on the predetermined utility. As mentioned, these N APs may e.g. be selected based on which combination of N APs that results in the highest sum of path gains. Here the path gains are between AP and wireless devices.

The method also comprises selecting 322 iteratively N APs 110 out of a set of remaining APs that are different APs from the previously selected APs, using a one-by-one assignment to respective wireless devices 121 based on the predetermined utility. In other words, the step in the previous paragraph is repeated for the remaining APs that has not previously been selected. This is done until less than N not selected APs remain. The remaining not selected APs may be assigned to respective wireless devices in a similar way as in the previous paragraph, i.e., based on a predetermined utility.

The method further comprises assigning 331 each APs 110 selected for a wireless device 121 scheduled for UL transmission to operate in UL, and assigning each AP selected for a wireless device scheduled for DL transmission to operate in DL.

As mentioned, the one-by-one assignment may be based on the Munkres algorithm. This provides a computationally efficient assignment that results in close to optimal solution.

The utility function may comprise a first utility for wireless devices scheduled for UL and a second utility for wireless devices scheduled for DL. For example, interference may be accounted for differently for wireless devices scheduled for UL and for wireless devices scheduled for DL.

The utility function may comprise a matrix, where each entry of the matrix corresponds to a pair of an AP 110 and a wireless device 121, and where each entry comprises a link characteristic for the corresponding pair of AP and wireless device. As mentioned, the characteristic may e.g. be the path gain between the corresponding pair of AP and wireless device. Furthermore, each entry may be scaled by interference from other APs 110 and/or wireless devices 121 than said pair of AP and wireless device. In addition, each entry may be normalized according to a predetermined normalization function. This may make the computations performed in the assignment more efficient. The normalization function may e.g. be based on the softmax function.

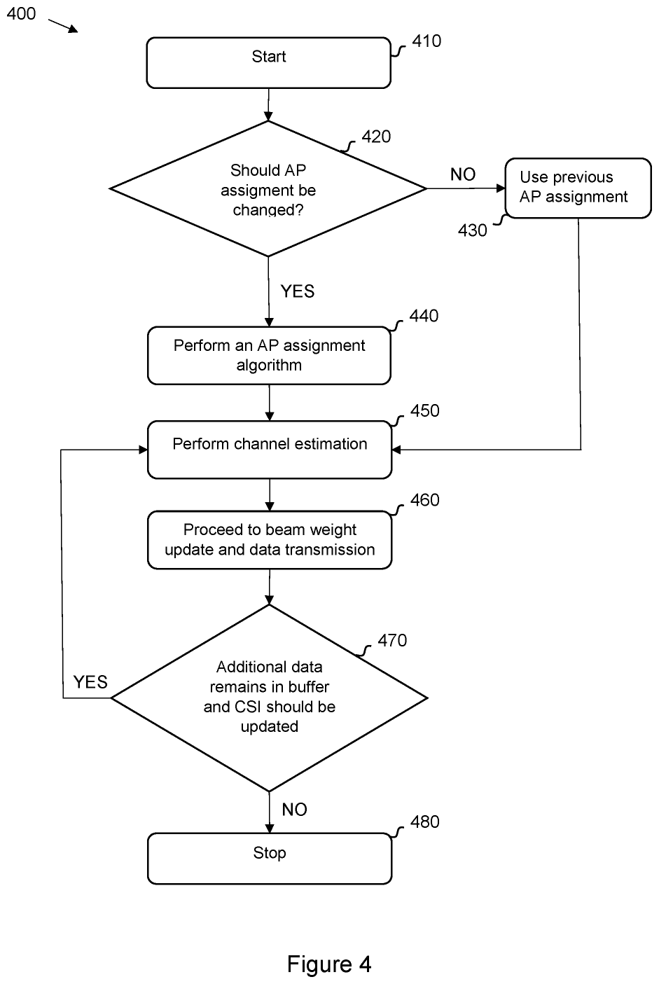

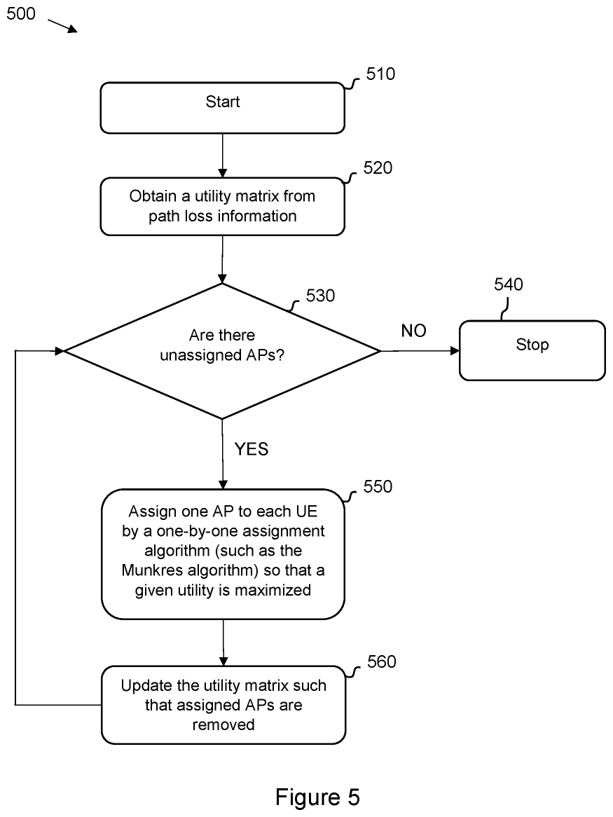

FIG. 4 shows a flowchart of an example embodiment of a method 400 including steps from AP assignment to data transmission. FIG. 5 shows a flowchart of an example embodiment 500 of the disclosed method for AP assignment. The example embodiment of FIG. 5 may constitute the assignment step 440 in FIG. 4.

In FIG. 4, the method starts at step 410. At step 420, the method determines whether a current AP assignment should be changed. If there has been no significant change in the wireless communications network, there may be no need to change the AP assignment. If, on the other hand, there is change, such as one or more wireless devices moving within the wireless communications network, it may be desired to change the AP assignment. If it is decided to keep the current AP assignment, the method proceeds to step 450, which is discussed below. If it is decided to change the AP assignment, the method proceeds to step 440 to make a new AP assignment. Thereafter, the method proceeds to step 450.

At step 450, the method performs a channel estimation between the APs and the wireless devices. This step may utilize data of the wireless communications network also used for the assignment step 440. Next, the method proceeds to step 460 that updates beam weights used in the D-MIMO system and transmits/receives data in UL and DL. At step 470, the method checks if any data remains in the buffer and if the channel estimation should be updated. If that is the case, the method goes back to step 450. If that is not the case, the method stops 480.

In FIG. 5, the method 500 starts at step 510. In step 520, the method obtains a utility matrix from path loss information between wireless devices and APs in the wireless communications network. The method thereafter iteratively assigns each AP to operate in UL or DL in steps 530, 550, and 560. Once every AP has been assigned, the method stops at step 540. At step 530, the method checks wheatear there are unassigned APs. If there are unassigned APs, the method assigns one AP to each UE by a one-by-one assignment algorithm (such as the Munkres algorithm) so that a given utility is maximized. Here, the assignment to an UE includes assigning the AP to operate in UL or DL depending on if the UE has requested UL or DL. At step 560, the method updates the utility matrix such that assigned APs are removed. This means that previously assigned APs cannot be assigned again.

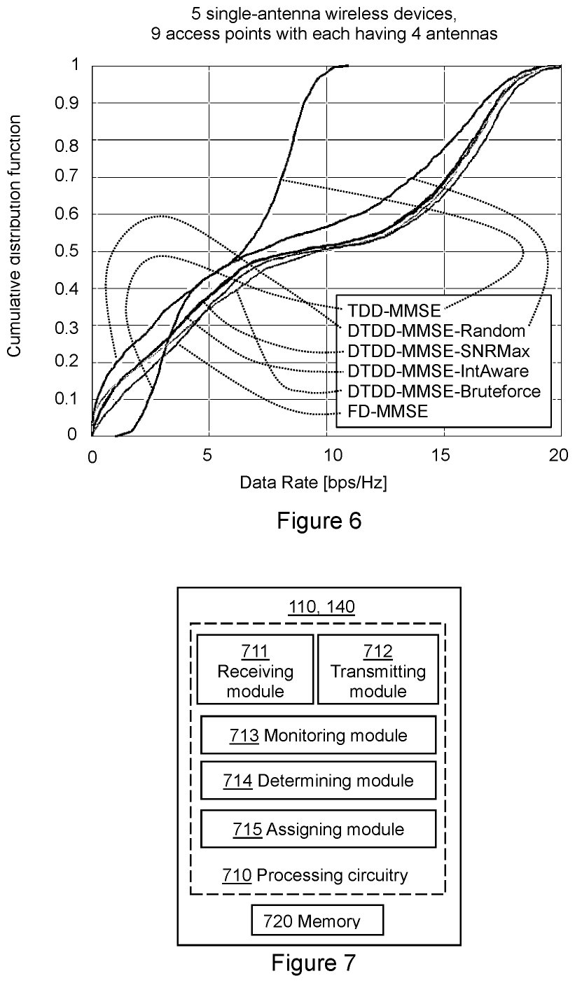

FIG. 6 shows a spectrum efficiency comparison for various AP selection methods with minimum mean square error (MMSE) beamforming. In particular, nine APs with four antennas each serve five UL or DL UEs over 5 GHz bands. While of some of the advantages of the disclosed methods lye on the fact that they require 1) lower communication fronthaul overhead, 2) lower computational cost, and 3) lower latency compared to state-of-the-art methods, FIG. 6 provides a performance comparison in terms of spectrum efficiency for various UL/DL AP assignment methods in order to show that the performance loss of the disclosed methods, compared to an exhaustive search (global optimum), is marginal.

The assumptions made here are as follows. The transmit power is set to 100 mW at UEs and 100 mW at APs. The data rate is calculated by the Shannon channel capacity formula with SINR formulations by equation (1) and (2). The path loss is modelled by the 3GPP Indoor Hotspot path loss model (namely, 3GPP TR 38.901 V 14.0.0 InH-Office in Table 7.4.1-1 and LOS/NLOS probability according to Table 7.4.2-1), while the fading is modelled as a Rayleigh random variable. It is assumed that APs are distributed in a square grid fashion, while UEs are distributed randomly within a square service area with one-side length of 50 meter. The beamforming weights are designed such that the mean square error (MSE) of equation (1) and (2) is minimized (i.e., MMSE) with instantaneous channel information.

The figure compares the following methods:

1. A TDD scenario where the available time is divided into UL and DL in an equal manner. Since there is no cross-interference, the SINR is calculated without UE-UE interference and AP-AP interference (see equations (1) and (2) for comparison). In other words, this method represents a conventional TDD scenario where UL and DL is separated in time. This particular assignment is denoted as TDD-MMSE in FIG. 6.

2. A DTDD scenario where the AP assignment is done randomly. Whether each AP is assigned to UL/DL is determined by a Bernoulli process with the equal probability being UL/DL. In order to ensure at least one AP serving UL/DL, one AP is randomly selected to serve DL/UL in case all APs are chosen to be UL/DL. This particular assignment is denoted as DTDD-MMSE-Random in FIG. 6.

3. A DTDD scenario where the AP UL/DL assignment is done based on a search over all combinations such that the sum Shannon capacity of all UEs is maximized for a given instantaneous channel realization. This serves as an upper bound of a scenario where the AP UL/DL assignment is done based on instantaneous CSI. In other words, this represents a global optimum of possible assignments. This particular assignment is denoted as DTDD-MMSE-Bruteforce in FIG. 6.

4. A FD scenario where all APs are assumed to be capable of in-band full-duplex operation. In the simulation result below, it is assumed that the self-interference channel is partially suppressed by 80 dB by means of passive and active self-interference cancellation techniques. This particular assignment is denoted as FD-MMSE in FIG. 6.

5. A DTDD scenario where the AP UL/DL assignment is done according to an example embodiment of the method disclosed herein. In particular, this assignment uses the example method described in the four steps in connection to Tables I and II. This particular assignment is denoted as DTDD-MMSE-SNRMax in FIG. 6.

6. A DTDD scenario where the AP UL/DL assignment is done according to an example embodiment of the method disclosed herein. In particular, this assignment uses the example method described in the four steps in connection to Table III. This particular assignment is denoted as DTDD-MMSE-IntAware in FIG. 6.

As shown in FIG. 6, the example embodiments of the disclosed method are able to outperform DTDD-MMSE-Random in terms of spectrum efficiency, while approaching the ideal case (DTDD-MMSE-Bruteforce). Interestingly, the example embodiments of the disclosed method also approaches the full-duplex scenario (FD-MMSE) even though the disclosed methods are assumed to be equipped only with half-duplex APs.

There is also disclosed herein a node 110, 140 for access point assignment in a wireless communications network 100 where multiple APs 110 simultaneously serve multiple wireless devices 121, where some of the multiple wireless devices are scheduled for uplink and some of the multiple wireless devices are scheduled for downlink. The node may be an AP 110 and/or a data processing unit 140.

FIG. 7 shows a schematic block diagram of embodiments of an AP 110. The schematic block diagram in FIG. 7 also represents embodiments of a data processing unit 140, which in this example have the same components. The embodiments of the node 110, 140 may be considered as independent embodiments or may be considered in any combination with each other. It should also be noted that, although not shown in FIG. 7, the node may comprise known conventional features for such devices, such as a power source like a battery or mains connection. If the node is an AP 110, the conventional features may be e.g. an antenna arrangement.

The node 110, 140 may comprise processing circuitry 710 and a memory 720. The processing circuitry 710 may comprise a receiving module 711 and a transmitting module 712. The receiving module 711 and the transmitting module 712 may comprise radio frequency circuitry and baseband processing circuitry capable of transmitting and receiving a radio signal in the wireless communications network 100. The receiving module 711 and the transmitting module 712 may also form part of a single transceiver. It should also be noted that some or all of the functionality described in the embodiments above as being performed by the node 110, 140 may be provided by the processing circuitry 710 executing instructions stored on a computer-readable medium, such as, e.g. the memory 720 shown in FIG. 7. Alternative embodiments of the node 110 may comprise additional components, such as, a monitoring module 713, an estimating module 714, and/or an assigning module 715, responsible for providing functionality to support the embodiments of the node described herein.

The node 110, 140, processing circuitry 710, or monitoring module 713 is configured to monitor link characteristics between the access points 110 and the wireless devices 121 over time. The node 110, 140, processing circuitry 710, or determining module 714 is further configured to determine, when at least one link characteristic changes more than a predetermined amount, a utility function based on the monitored link characteristics. The utility function is a function of a predetermined utility in terms of link quality in the wireless communications network 100 versus a possible uplink or downlink assignment for each access point. The node 110, 140, processing circuitry 710, or assigning module 715 is further configured to assign one or more APs to operate in either uplink or downlink based on the utility function. Preferably, each access point is assigned either uplink or downlink.

The node 110, 140, processing circuitry 710, or assigning module 715 may be further configured to communicate the uplink and downlink assignments to the corresponding access points 110.

The link characteristics may comprise any of path gain, received power, transmitted power, signal-to-noise ratio, SNR, signal-to-interference-plus-noise ratio, SINR, spatial channel correlation, and channel rank. Furthermore, the predetermined utility may comprises any of path gain, received power, transmitted power, SNR, SINR, spatial channel correlation, channel rank and data capacity. In addition, the utility may comprise information of interference from one or more APs 110 and/or one or more wireless devices 121 in the wireless communications network 100.

According to some aspects, the wireless communications network 100 comprises a number M access points 110 and a number N wireless devices 121 scheduled for uplink or downlink, where M is larger than N. In that case, the node 110, 140 or processing circuitry 710 is further configured to select N access points 110 out of M possible access points using a one-by-one assignment to respective wireless devices 121 based on the predetermined utility, select iteratively N access points 110 out of a set of remaining access points that are different access points from the previously selected access points, using a one-by-one assignment to respective wireless devices 121 based on the predetermined utility, and assign each access point 110 selected for a wireless device 121 scheduled for uplink transmission to operate in uplink, and assigning each access point selected for a wireless device scheduled for downlink transmission to operate in downlink.

The one-by-one assignment may be based on the Munkres algorithm. Furthermore, the utility function may comprise a first utility for wireless devices 121 scheduled for uplink and a second utility for wireless devices 121 scheduled for downlink.

The utility function may comprises a matrix, where each entry of the matrix corresponds to a pair of an access point 110 and a wireless device 121, and where each entry comprises averaged link information for the corresponding pair of an access point and a wireless device. In that case, each entry may be scaled by interference from other access points 110 and/or wireless devices 121 than said pair of an access point and a wireless device. Furthermore, each entry may be normalized according to a predetermined normalization function. The normalization function may be based on the softmax function.

The node 110, 140 or processing circuitry 710 may be configured to monitor whether the at least one link characteristic changes more than the predetermined amount in a predetermined time interval. In that case, the predetermined time interval may be based on past link characteristics. Alternatively, or in combination of, the predetermined time interval may be based on an expected time the respective wireless devices are expected to move less than a predetermined distance. As an example, the predetermined amount of time is 0.1-10 seconds.

The methods disclosed herein may be implemented through one or more processors, such as the processing circuitry 710 in the node 110, 140 depicted in FIG. 7, together with computer program code for performing the functions and actions of the embodiments herein. The program code may also be provided as a computer program product, for instance in the form of a data carrier carrying computer program code or code means for performing the embodiments herein when being loaded into the processing circuitry 710 in the node 110, 140. The computer program code may e.g. be provided as pure program code in the node 110, 140 or on a server and downloaded to the node. Thus, it should be noted that the modules of the node 110, 140 may in some embodiments be implemented as computer programs stored in memory, e.g. in the memory modules 720 in FIG. 7, for execution by processors or processing modules, e.g. the processing circuitry 710 of FIG. 7. Those skilled in the art will also appreciate that the processing circuitry 710 and the memory 720 described above may refer to a combination of analog and digital circuits, and/or one or more processors configured with software and/or firmware, e.g. stored in a memory, that when executed by the one or more processors such as the processing circuitry 710 perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

It should also be noted that the various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The embodiments herein are not limited to the above-described preferred embodiments. Various alternatives, modifications and equivalents may be used. Therefore, the above embodiments should not be construed as limiting.

1. A computer-implemented method for access point assignment in a wireless communications network where multiple access points simultaneously serve multiple wireless devices, and where some of the multiple wireless devices are scheduled for uplink and some of the multiple wireless devices are scheduled for downlink, the method comprising:
monitoring link characteristics between the access points and the wireless devices over time;
determining, when at least one link characteristic changes more than a predetermined amount, a utility function based on the monitored link characteristics, wherein the utility function is a function of a predetermined utility in terms of link quality in the wireless communications network versus a possible uplink or downlink assignment for each access point; and
assigning one or more access points to operate in either uplink or downlink based on the utility function.

2. The method according to claim 1, further comprising communicating the uplink and downlink assignments to the corresponding access points.

3. The method according to claim 1, where the link characteristics comprise any of path gain, received power, transmitted power, signal-to-noise ratio (SNR) signal-to-interference-plus-noise ratio (SINR) spatial channel correlation, and channel rank.

4. The method according to claim 1, wherein the predetermined utility comprises any of path gain, received power, transmitted power, SNR, SINR, spatial channel correlation, channel rank and data capacity.

5. The method according to claim 1, wherein the utility comprises information of interference from one or more access points and/or one or more wireless devices in the wireless communications network.

6. The method according to claim 1, wherein the wireless communications network comprises a number M access points and a number N wireless devices scheduled for uplink or downlink, where M is larger than N, where the method comprises:
selecting N access points out of M possible access points using a one-by-one assignment to respective wireless devices based on the predetermined utility;
selecting iteratively N access points out of a set of remaining access points that are different access points from the previously selected access points, using a one-by-one assignment to respective wireless devices based on the predetermined utility; and
assigning each access point selected for a wireless device scheduled for uplink transmission to operate in uplink, and assigning each access point selected for a wireless device scheduled for downlink transmission to operate in downlink.

7. The method according to claim 6, wherein the one-by-one assignment is based on the Munkres algorithm.

8. The method according to claim 1, wherein the utility function comprises a first utility for wireless devices scheduled for uplink and a second utility for wireless devices scheduled for downlink.

9. The method according to claim 1, where the utility function comprises a matrix, where each entry of the matrix corresponds to a pair of an access point and a wireless device, and where each entry comprises a link characteristic for the corresponding pair of access point and wireless device.

10. The method according to claim 9, wherein each entry is scaled by interference from other access points and/or wireless devices than the pair of access point and wireless device.

11. The method according to claim 9, wherein each entry is normalized according to a predetermined normalization function.

12. The method according to claim 11, wherein the normalization function is based on the softmax function.

13. The method according to claim 1, further comprising monitoring whether the at least one link characteristic changes more than the predetermined amount in a predetermined time interval.

14. The method according to claim 13, wherein the predetermined time interval is based on past link characteristics.

15. The method according to claim 13, wherein the predetermined time interval is based on an expected time the respective wireless devices are expected to move less than a predetermined distance.

16. The method according to claim 1, wherein the predetermined time interval is 0.1-10 seconds.

17. A node for access point assignment in a wireless communications network where multiple access points simultaneously serve multiple wireless devices, and where some of the multiple wireless devices are scheduled for uplink and some of the multiple wireless devices are scheduled for downlink, wherein the node comprises a processing circuitry and a memory, the processing circuitry being configured to:
monitor link characteristics between the access points and the wireless devices over time;
determine, when at least one link characteristic changes more than a predetermined amount, a utility function based on the monitored link characteristics, wherein the utility function is a function of a predetermined utility in terms of link quality in the wireless communications network versus a possible uplink or downlink assignment for each access point; and
assign one or more access points to operate in either uplink or downlink based on the utility function.

18. The node according to claim 17, wherein the processing circuitry is further configured to communicate the uplink and downlink assignments to the corresponding access points.

19. The node according to claim 17, where the link characteristics comprise any of path gain, received power, transmitted power, signal-to-noise ratio (SNR) signal-to-interference-plus-noise ratio (SINR) spatial channel correlation, and channel rank.

20. The node according to claim 17, wherein the predetermined utility comprises any of path gain, received power, transmitted power, SNR, SINR, spatial channel correlation, channel rank and data capacity.

21.-35. (canceled)
